(19) United States
(12) Patent Application Publication
(10) Pub. No.: US 2019/0034554 A1
(43) Pub. Date: Jan. 31, 2019

(54) EXTEND CONVERSATIONAL SESSION WAITING TIME

(71) Applicant: Lenovo (Singapore) Pte. Ltd., Singapore (SG)

(72) Inventors: Ryan Charles Knudson, Durham, NC (US); Kushagra Jindal, Cary, NC (US); Roderick Echols, Chapel Hill, NC (US); Timothy Winthrop Kingsbury, Cary, NC (US)

(21) Appl. No.: 15/662,396

(22) Filed: Jul. 28, 2017

(51) Int. Cl. G06F 17/30

(52) U.S. Cl. CPC G06F 17/30976

(57) ABSTRACT

One embodiment provides a method, including: engaging, at an information handling device, in a conversational session with a user; receiving, during the conversational session, a query input; determining, at the information handling device, whether the query input has been completed; and extending, responsive to determining that the query input has not been completed, the waiting time for receipt of the query input. Other aspects are described and claimed.

### BACKGROUND

Information handling devices (“devices”), for example smart phones, tablet devices, smart speakers, laptop and personal computers, and the like, may be capable of receiving command inputs and providing outputs responsive to the inputs. Generally, a user interacts with a voice input module, for example embodied in a personal assistant through use of natural language. This style of interface allows a device to receive voice inputs from a user (e.g., queries, commands, etc.), process those inputs, and provide audible outputs according to preconfigured output settings (e.g., preconfigured output speed, etc.). Once the query input from the user has been received the digital assistant processes the input and performs a function in response to the received query input.

### BRIEF SUMMARY

In summary, one aspect provides a method, comprising: engaging, at an information handling device, in a conversational session with a user; receiving, during the conversational session, a query input; determining, at the information handling device, whether the query input has been completed; and extending, responsive to determining that the query input has not been completed, the waiting time for receipt of the query input.

Another aspect provides an information handling device, comprising: a processor; a memory device that stores instructions executable by the processor to: engage in a conversational session with a user; receive, during the conversational session, a query input; determine whether the query input has been completed; and extend, responsive to determining that the query input has not been completed, the waiting time for receipt of the query input.

A further aspect provides a product, comprising: a storage device that stores code, the code being executable by a processor and comprising: code that engages in a conversational session with a user; code that receives, during the conversational session, a query input; code that determines whether the query input has been completed; and code that extends, responsive to determining that the query input has not been completed, the waiting time for receipt of the query input.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of extending a waiting time for receipt of query input.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users frequently utilize devices to execute a variety of different commands or queries. One method of interacting with a device is to use digital assistant software employed on the device (e.g., Siri® for Apple®, Cortana® for Windows®, Alexa® for Amazon®, etc.). Digital assistants are able to provide outputs (e.g., audible outputs, visual outputs, etc.) that are responsive to a variety of different types of user inputs (e.g., voice inputs, etc.).

In conventional digital assistant sessions, the user provides a query input and the assistant performs a function associated with that input. The term query input will be used here throughout. However, it should be understood by one skilled in the art that query input does not necessarily mean a question to the digital assistant. For example, the user may provide a command, for example, “dim the lights”, for the assistant to process and complete. In other words, a query input includes any type of input provided to a digital assistant for processing, whether that is a question, command, or other type of input.

Conventional assistant software provides a predetermined amount of time for receipt of query input. For example, after the assistant software has been activated, the system waits for a predetermined amount of time to receive a query input from the user. If the predetermined amount of time expires before receipt of an input, the system will “time out” and the user will have to reactivate the software before providing the query input. Additionally, in conventional systems, the system provides a predetermined amount of time before processing a received query input. For example, if the user starts to provide input and then pauses, the system provides a predetermined amount of time before processing the input. If no additional input is received during the predetermined amount of time, the system will process the query input. However, the system processes the input even if the input is only a partial query input. In other words, if the user provides part of the input and pauses and fails to provide the remaining input within the predetermined time, the system will process the partial input that the user provided. This may lead to frustration and confusion, because the system processes the partial input which is likely not what the user actually wanted the system to process. The user then has to reactivate the system and provide the entire input again in order to get the desired result from the assistant.

Generally the predetermined time is set by the system as a default and is intended to minimize waiting time for processing the query input. In other words, the predetermined time is set such that, after the user has finished providing query input, the user will not have to wait a long time until the assistant attempts to process the query input, thereby minimizing user impatience. However, the system cannot and does not determine if the user has actually finished providing the query input or is just pausing during provision of the query input. Thus, even if a user has only provided a partial input, the system attempts to process the input after expiration of the predetermined time. This results in frustration by the user. Not only does the user have to wait until the system attempts to process the partial input and provide some response based upon the partial input, but the user then has to reactivate the system and provide the query input that the user actually wanted processed.

Accordingly, an embodiment provides a method of extending the waiting time for receipt of a query input based upon determining that the query input has not been completed. An embodiment may engage in a conversational session with a user. During this conversational session, an embodiment may receive a query input. Receipt of the query input may include receiving any portion of the query input. For example, the user may provide a single word, a phrase, an almost completed query input, the whole query input, or the like.

An embodiment may then determine whether the query input has been completed. In other words, an embodiment may determine whether the query input is a partial input or whether it represents a fully completed query input. Identifying the query input as partial input may include detecting a filler word or pause (e.g., um, uh, hold on, just a second, etc.), detecting an unexpected pause within the query input, accessing a query history associated with the user, accessing a crowd-sourced data source, or the like. Upon determining that the query input has not been completed, an embodiment may extend the waiting time for receipt of the query input. In other words, an embodiment may extend the amount of time that the assistant waits before processing the query input. Alternatively, an embodiment may determine that the query input has been completed and may process the query input, thereby reducing the waiting time before processing of the query input. Such a method may assist the user in conversing with a digital assistant by extending a waiting time after receipt of a partial query input and decreasing a waiting time after receipt of a complete query input.

The illustrated example embodiments will be best understood by reference to the figures. The following description is intended only by way of example, and simply illustrates certain example embodiments.

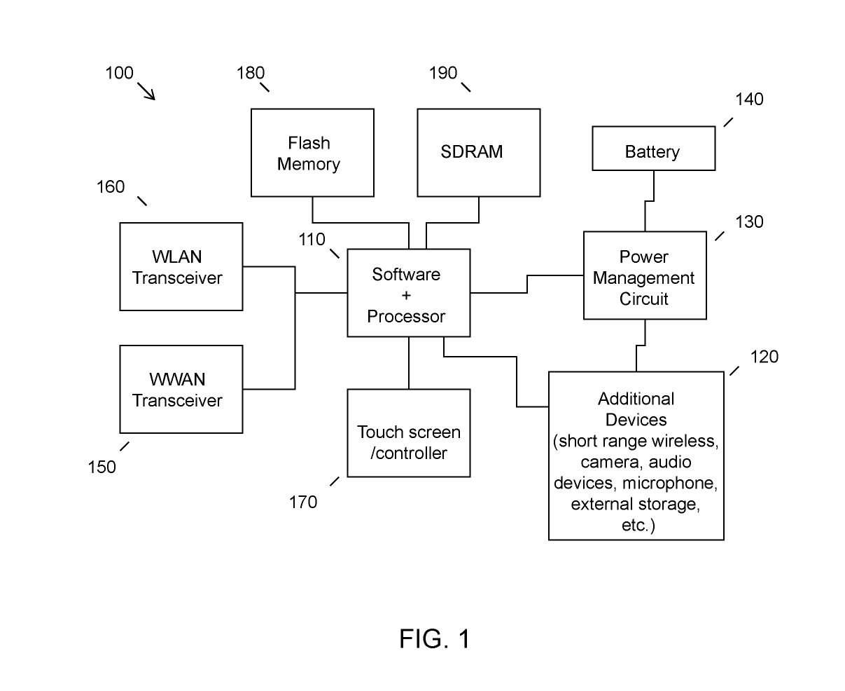

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen 170 for data input and display/rendering. System 100 also typically includes various memory devices, for example flash memory 180 and SDRAM 190.

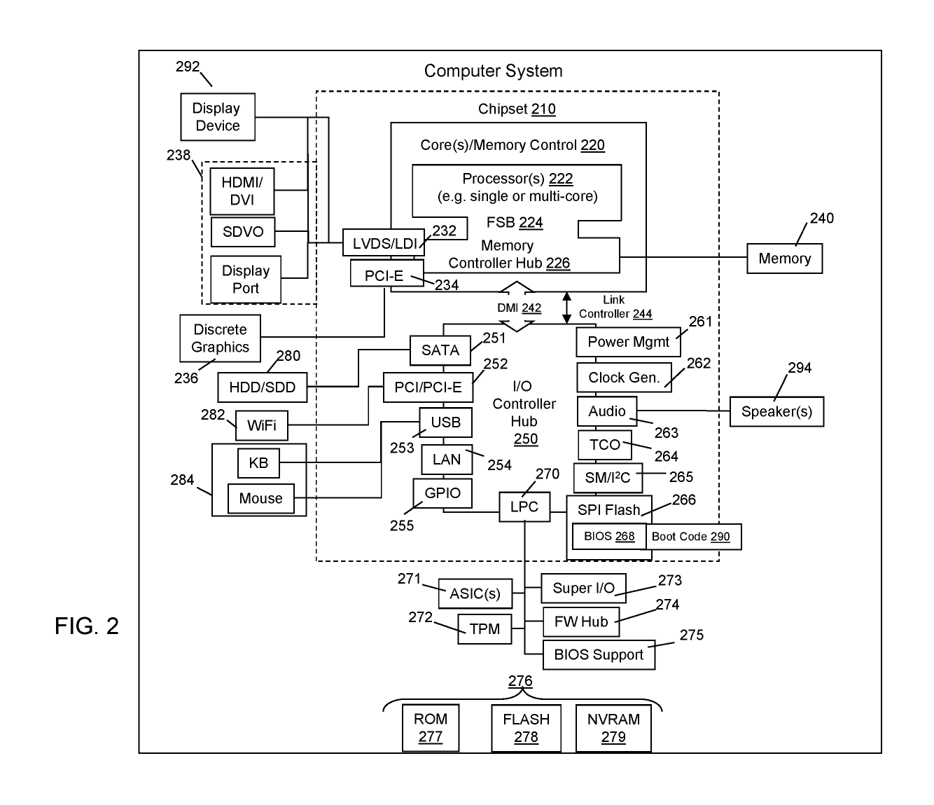

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, smart speakers, personal computer devices generally, and/or electronic devices which enable users to communicate with a digital assistant. For example, the circuitry outlined in FIG. 1 may be implemented in a tablet or smart phone embodiment, whereas the circuitry outlined in FIG. 2 may be implemented in a personal computer embodiment.

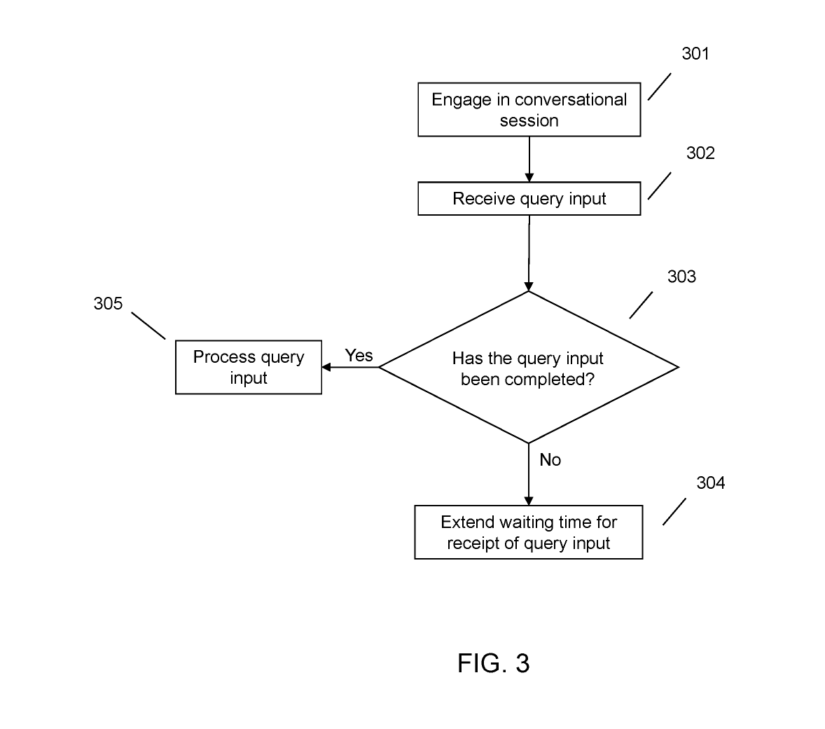

Referring now to FIG. 3, at 301, an embodiment may engage in a conversational session with a user. A conversational session may be defined as a session with a digital assistant or other interactive application in which a user provides input, the digital assistant processes or analyzes the input, and the digital assistant then provides an output responsive to the input. A conversational session may include a single exchange of input and output, referred to herein as a single-turn conversational session, or multiple exchanges of input and output, referred to herein as a multi-turn interaction session.

Engagement in the conversational session may be based upon an indication to begin a conversational session. In an embodiment the indication may include a wakeup input or action provided by a user (e.g., one or more wakeup words or predetermined commands, a depression of a button for a predetermined length of time, a selection of a digital assistant icon, etc.). In an embodiment, the wakeup action may be provided prior to or in conjunction with user input. For example, a user may provide the vocal input, “Ok Surlexana, order a pizza.” In this scenario, “Ok Surlexana” is the wakeup word and upon identification of the wakeup word an embodiment may prime the system to listen for additional user input. Responsive to the identification of the wakeup action, an embodiment may initiate a conversational session. In another embodiment, the indication may not be associated with a wakeup action. For example, the system may simply “listen” to the user and determine when the user is providing input directed at the system. The conversational session may then be initiated when the system determines that the user input is directed to the system.

Once an embodiment has initiated the conversational session, an embodiment may receive a query input from the user at 302. During the conversational session, an embodiment may receive user input (e.g., voice input, touch input, etc.) including or associated with a user query or a user command, referred to herein as a query input, at a device (e.g., smart phone, smart speaker, tablet, laptop computer, etc.). In an embodiment, the device may employ digital assistant software capable of receiving and processing user input and subsequently providing output (e.g., audible output, textual output, visual output, etc.) corresponding or responsive to the user input. In an embodiment, the user input may be any input that requests the digital assistant to provide a response. For example, the user may ask the digital assistant a general question about a topic, the user may ask the digital assistant to provide instructions to assemble an object, the user may ask the digital assistant's opinion on a topic, the user may make a statement which allows a response, and the like.

The input may be received at an input device (e.g., physical keyboard, on-screen keyboard, audio capture device, image capture device, video capture device, etc.) and may be provided by any known method of providing input to an electronic device (e.g., touch input, text input, voice input, etc.). For simplicity purposes, the majority of the discussion herein will involve voice input that may be received at an input device (e.g., a microphone, a speech capture device, etc.) operatively coupled to a speech recognition device. However, it should be understood that generally any form of user input may be utilized. For example, the user may provide text input to the digital assistant, for example, through a chat assistant or instant messaging application.

In an embodiment, the input device may be an input device integral to the digital assistant device. For example, a smart phone may be disposed with a microphone capable of receiving voice input data. Alternatively, the input device may be disposed on another device and may transmit received input data to the digital assistant device. For example, voice input may be received at a smart speaker that may subsequently transmit the voice data to another device (e.g., to a user's smartphone for processing, etc.). Input data may be communicated from other sources to the digital assistant device via a wireless connection (e.g., using a BLUETOOTH connection, near field communication (NFC), wireless connection techniques, etc.), a wired connection (e.g., the device is coupled to another device or source, etc.), through a connected data storage system (e.g., via cloud storage, remote storage, local storage, network storage, etc.), and the like.

In an embodiment, the input device may be configured to continuously receive input data by maintaining the input device in an active state. The input device may, for example, continuously detect input data even when other sensors (e.g., cameras, light sensors, speakers, other microphones, etc.) associated with the digital assistant device are inactive. Alternatively, the input device may remain in an active state for a predetermined amount of time (e.g., 30 minutes, 1 hour, 2 hours, etc.). Subsequent to not receiving any input data during this predetermined time window, an embodiment may switch the input device to a power off state. The predetermined time window may be preconfigured by a manufacturer or, alternatively, may be configured and set by one or more users.

At 303, an embodiment may determine whether the query input has been completed. In other words, an embodiment may determine whether the query input received at 302 was a partially completed query input or a fully completed query input. For example, when the user provided the query input the user may have gotten distracted during provision of the query input and failed to provide the complete query input. As another example, the user may be providing the query input and realize they do not have all of the information to complete the query input and may look for the remaining information while providing the query input, thereby providing a partial query input, following by a pause or delay, and then provision of the remaining portion of the query input. In conventional systems, if the pause or delay exceeds the predetermined time period, the system would process the query input without receiving the remaining portion of the query input.

The term partial query input refers to query input that has not been completed as intended by the user. For example, if the user intended to provide the query input “order a pizza with pepperoni” and instead provides the query input “order a pizza”, the provided input may be considered partial or uncompleted query input. In other words, even if the system could process the query input as received, the query input may still be considered partial query input because it was not the query input the user intended to provide. Thus, partial query input does not necessarily only include query input that the system cannot process or that would result in response from system indicating that the input cannot be processed.

To determine if the query input is partial or complete query input, an embodiment may detect one or more pause indicators. In one embodiment, the pause indicator may include a filler word or natural language pause. Example filler words or natural language pauses include, but are not limited to, “um”, “uh”, “hold on”, “just a second”, “ah”, “like”, and the like. As an example, the user may provide the query input “navigate me to uhhh . . . .” An embodiment may detect the filler word “uhhh” and recognize the query input a partial query input. Filler words and natural language pauses may also be unique to a particular individual or user. Accordingly, in one embodiment, the system may learn the filler words and natural language pauses for a particular individual and associate these words as filler words or natural language pauses.

In one embodiment, the pause indicator may include a pause in the query input. For example, the user may provide the query input “play the song . . . .” An embodiment may detect the pause and determine that the input is partial input. Detection of the pause indicating a partial query input as opposed to completion of the query input may include determining that the query input as provided would result in a request that cannot be fulfilled by the system. In this example, the assistant would recognize that no song could be selected because the song was not identified in the query input. Therefore, an embodiment may determine that the detected pause is a delay in provision of the remaining portion of the query input as opposed to a pause associated with a completed query input. Detection of the pause may also be based upon a user history of query inputs or crowd-sourced data, both of which are discussed in more detail below. Upon detection of the pause indicator, an embodiment may determine that the received query input is a partial query input.

In one embodiment determining whether the query input has been completed or not may be based upon a query history associated with the user. An embodiment may access a query history including previously completed queries or query types. The query history may identify a structure of a query input completed by the user. The query history may identify different query types or different query structures based upon the topic or request of the query input. For example, a query input requesting navigation may have a different structure than a query input requesting a pizza order.

An embodiment may identify typical query input provided by the user from the query history. An embodiment may then compare the received query input to the typical query inputs and determine whether the structure of the received query input matches the typical query inputs. As an example, an embodiment may determine that a user typically provides navigation requests by highway numbers, for example, “navigate me to 40”. Accordingly, if a user provides the query input “navigate me to 80”, an embodiment, based upon the comparison to the typical query inputs, may identify this as a complete query input. The comparison may be made against the typical query inputs matching the topic or request of the received input. For example, if the received query input is a navigation input, the typical query inputs used for comparison may only include navigation inputs rather than all query inputs.

The user history may also be used to determine whether the query input is complete based upon a user's response to previously processed query input. For example, if the system has previously processed a query input and the user provides feedback that the query input was not complete (e.g., the next provided input included the previously received input plus additional information, the user indicates that the input was not complete, the user yells at the system in frustration, the user seems frustrated with the response, etc.), an embodiment may use this information to determine whether the received query input is complete. As a contrasting example, if the system has previously processed a query input and the user provides feedback that the query input was complete (e.g., the user accepts the provided response by the assistant, the user responds in the affirmative, the user provides no additional input, etc.), an embodiment may use this information to determine whether the received query input is complete.

Determining whether the query input is complete may be based upon crowd-sourced data. The crowd-sourced data may identify typical structures of complete query inputs. As with the user history, the crowd-sourced data may be divided into topics, categories, or types of query input. An embodiment may compare the received query input to the crowd-sourced query input structures. Based upon the comparison, an embodiment may determine whether the query input is likely a complete query input or a partial query input. Comparison to crowd-sourced data may be based upon features of the user. For example, an embodiment may determine that the user is of a particular age and may therefore use crowd-sourced data from other users around the same age of the user. As another example, an embodiment may determine that the user is from a particular region and may therefore use crowd-sourced data from other users in the same region.

The described techniques may be used alone or in combination. For example, an embodiment may detect a pause and then use crowd-sourced data to confirm whether the received input is partial or complete. Additionally, any of the techniques described herein can be used to determine that the query input is a partial query input or a complete query input. In other words, the techniques as described herein may not only be used to determine that the query input is a partial query input.

If an embodiment determines that the query input has been completed at 303, an embodiment may process the query input at 305. This may include reducing the waiting time between completion of the query input and the processing of the input. In other words, if an embodiment determines that the query input is complete or is likely complete an embodiment may process the input without waiting for the predetermined time frame to elapse. Such a technique may minimize the impatience of the user. Alternatively, if an embodiment determines that the query input has not been completed or is a partial query input at 303, an embodiment may extend the waiting time for receipt of the query input at 304.

Extending the waiting time may include extending the waiting time by a predetermined amount. This predetermined amount may vary depending on the topic, type, and the like, of the query input or the application associated with the query input. For example, the predetermined amount of time may be more for a navigation application query input as opposed to a music application query input. As another example, the predetermined amount of time may be more for a pizza order as opposed to a taco order. The predetermined amount of time may also vary based upon the user providing the query input. For example, the predetermined amount of time may be more for a child than for an adult. In this respect, the predetermined amount of time may be different for a particular user (e.g., “John” vs. “Jim”) or may be different for a group of users based upon a characteristic of the user (e.g., age, gender, location, native-language speaker, etc.). The predetermined amount of time may also vary based upon where the user is providing the input. For example, if the user is in a car providing input, the predetermined amount of time may be longer than if the same user is at home.

Upon extending the waiting time, an embodiment may provide an indication to the user that the device is waiting for additional input. In one embodiment the indication may include providing a visual indication (e.g., blinking light, pop-up notification, etc.). In one embodiment the indication may include providing an audible indication (e.g., stating “waiting on additional input”, providing music during the waiting time, periodic beep, etc.). One embodiment may provide a haptic notification (e.g., vibrating, “tap”, etc.). A combination of notifications may also be provided. For example, in one embodiment a blinking light may be provided and the device may provide an audible notification that it is waiting on additional input.

Upon identifying that the partial query input has been completed, an embodiment may perform a function associated with the received query input. Identification of the completion of the query input may be based upon receiving feedback from the user indicating that the partial query input has now been completed. For example, the user may say “ok, now process”, “I'm done”, “finished”, or the like. Other completion identification may be used. For example, the user may provide non-audible input indicating the query input has been completed (e.g., pushing a button, clicking an icon, etc.). As another example, an embodiment may have a predetermined time that begins after receiving the second portion of the query input. Expiration of the time may trigger the system to process the query input. Upon receipt of the second portion of the query input, the system may use the techniques as described herein to determine if the second portion in conjunction with the first portion comprises a completed input. In other words, if a user provides the query input “order umm a pizza from . . . ” the system may identify the filler word, which may extend the waiting time, and then the pause, which may again extend the waiting time.

The various embodiments described herein thus represent a technical improvement to conventional communications with a digital assistant. Using the methods and systems as described herein, the waiting time associated with processing a query input can be dynamically adjusted based upon whether the query input has been completed or not. Upon determining that the query input is a partial query input, an embodiment may extend the waiting time before processing the query input. Upon determining that the query input is a complete query input, an embodiment may reduce the waiting time before processing the query input. Such a system reduces the amount of frustration caused by the digital assistant processing incomplete or partial query input and the user having to start the entire process over in order to produce the desired results. Such techniques enable a more intuitive digital assistant that does not require the user to repeat query input because the system processed only a partial query input.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
engaging, at an information handling device, in a conversational session with a user;
receiving, during the conversational session, a query input;
determining, at the information handling device, whether the query input has been completed; and
extending, responsive to determining that the query input has not been completed, the waiting time for receipt of the query input.

2. The method of claim 1, wherein the determining whether the query input has been completed comprises determining that the query input has not been completed based upon detection of a filler word contained within the received query input.

3. The method of claim 1, wherein the determining whether the query input has been completed comprises determining that the query input has not been completed based upon detection of a pause contained with the received query input.

4. The method of claim 1, wherein the determining whether the query input has been completed comprises accessing a query history associated with the user.

5. The method of claim 4, wherein the accessed query history comprises a query history identifying structures of complete queries related to a topic of the query input.

6. The method of claim 1, wherein the determining whether the query input has been completed comprises accessing crowd-sourced data identifying structures of complete queries related to a topic of the query input.

7. The method of claim 1, wherein the extending the waiting time comprises extending the waiting time by a predetermined amount depending on a topic of the query input.

8. The method of claim 1, further comprising providing an indication notifying a user that the information handling device is waiting for additional input.

9. The method of claim 1, further comprising performing a function associated with the received query input upon indication of completion of the query input.

10. The method of claim 9, wherein the indication of completion comprises a user input indicating the query input is complete.

11. An information handling device, comprising:
a processor;
a memory device that stores instructions executable by the processor to:
engage in a conversational session with a user;
receive, during the conversational session, a query input;
determine whether the query input has been completed; and
extend, responsive to determining that the query input has not been completed, the waiting time for receipt of the query input.

12. The information handling device of claim 11, wherein the instructions executable by the processor to determine whether the query input has been completed comprise instructions executable by the processor to determine that the query input has not been completed based upon detection of a filler word contained within the received query input.

13. The information handling device of claim 11, wherein the instructions executable by the processor to determine whether the query input has been completed comprise instructions executable by the processor to determine that the query input has not been completed based upon detection of a pause contained with the received query input.

14. The information handling device of claim 11, wherein the instructions executable by the processor to determine whether the query input has been completed comprise instructions executable by the processor to access a query history associated with the user.

15. The information handling device of claim 14, wherein the accessed query history comprises a query history identifying structures of complete queries related to a topic of the query input.

16. The information handling device of claim 11, wherein the instructions executable by the processor to determine whether the query input has been completed comprise instructions executable by the processor to access crowd-sourced data identifying structures of complete queries related to a topic of the query input.

17. The information handling device of claim 11, wherein the instructions executable by the processor to extend the waiting time comprise instructions executable by the processor to extend the waiting time by a predetermined amount depending on a topic of the query input.

18. The information handling device of claim 11, wherein the instructions are further executable by the processor to provide an indication notifying a user that the information handling device is waiting for additional input.

19. The information handling device of claim 11, wherein the instructions are further executable by the processor to perform a function associated with the received query input upon indication of completion of the query input.

20. A product, comprising:
a storage device that stores code, the code being executable by a processor and comprising:
code that engages in a conversational session with a user;
code that receives, during the conversational session, a query input;
code that determines whether the query input has been completed; and
code that extends, responsive to determining that the query input has not been completed, the waiting time for receipt of the query input.
